(19) United States
(12) Patent Application Publication
(10) Pub. No.: US 2024/0233350 A1
(43) Pub. Date: Jul. 11, 2024

(54) PROCESSING METHOD, ELECTRONIC DEVICE, AND NON-TRANSITORY COMPUTER-READABLE STORAGE MEDIUM FOR MULTIMODAL DATA

(71) Applicants: Lemon Inc., Grand Cayman (KY); Beijing Zitiao Network Technology Co., Ltd., Beijing (CN)

(72) Inventors: Xiaojie JIN, Los Angeles, CA (US); Fan MA, Beijing (CN); Jiashi FENG, Singapore (SG); Heng WANG, Los Angeles, CA (US); Jingjia HUANG, Beijing (CN)

(21) Appl. No.: 18/408,967

(22) Filed: Jan. 10, 2024

(30) Foreign Application Priority Data
Jan. 10, 2023 (CN) 202310035955.X

(51) Int. Cl. G06V 10/80; G06F 40/284; G06V 10/774; G06V 20/40

(52) U.S. Cl. CPC G06V 10/806; G06F 40/284; G06V 10/774; G06V 20/46

(57) ABSTRACT

The embodiments of the disclosure provides a processing method, apparatus, electronic device and non-transitory computer-readable storage medium for multimodal data, wherein the method includes: obtaining data to be processed of an original modality; determining result data of a target modality corresponding to the data to be processed by processing the data to be processed with a target processing model; wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

### CROSS REFERENCE

The present application claims priority to Chinese Patent Application No. 202310035955.X, filed on Jan. 10, 2023 and entitled “PROCESSING METHOD, APPARATUS, ELECTRONIC DEVICE, AND STORAGE MEDIUM FOR MULTIMODAL DATA”, the entirety of which is incorporated herein by reference.

### FIELD

Embodiments of the present disclosure relate to the field of computer technology, and more particularly, to a processing method, apparatus, electronic device and storage medium for multimodal data.

### BACKGROUND

Currently, studies on multimodal deep learning have been widely conducted, which is committed to simultaneously processing at least two of modal data such as speech, text, images, and videos.

In the prior art, the pre-training process of multimodal submodels usually focuses on feature contrastive learning between global-dimensional multimodal data, while ignoring the correspondence between finer-grained features, thereby resulting in limited performance of pre-trained models on downstream multimodal data processing tasks.

### SUMMARY

The embodiments of the present disclosure provide a processing method, apparatus, electronic device and storage medium for multimodal data, enabling to establish fine-grained correspondence between multimodal data and enabling to improve the performance of pre trained models in downstream multimodal data processing tasks.

In a first aspect, the embodiments of the present disclosure provide a processing method for multimodal data, comprising: obtaining data to be processed of an original modality; determining result data of a target modality corresponding to the data to be processed by processing the data to be processed with a target processing model;

wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

In a second aspect, the embodiments of the present disclosure further provide a processing apparatus for multimodal data, comprising: a data obtaining module, used for obtaining data to be processed of an original modality; a data processing module, used for determining result data of a target modality corresponding to the data to be processed by processing the data to be processed with a target processing model; wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

In a third aspect, the embodiments of the present disclosure further provide an electronic device comprising: one or more processors; a storage device for storing one or more programs, when the one or more programs are executed by the one or more processors, the one or more processors are caused to implement the processing method for multimodal data according to any embodiment of the present disclosure.

In a fourth aspect, the embodiments of the present disclosure further provide a storage medium comprising computer-executable instructions, the computer-executable instructions, when executed by a computer processor, used for performing the processing method for multimodal data according to any embodiment of the present disclosure.

The technical solution of the embodiments of the present disclosure obtains the data to be processed of the original modality; determines the result data of the target mode corresponding to the data to be processed by processing the data to be processed with the target processing model; wherein the target processing model includes a multimodal submodel, and the pre-training task of the multimodal submodel includes the task of locating local data that matches the second modal data from the first modal data; wherein the target processing model includes a multimodal submodel, and the pre-training task of the multimodal submodel includes the task of locating local data that matches the second modal data from the first modal data; wherein when the first modal data belongs to the original modality, the second modal data belongs to the target modality; when the first modal data belongs to the target modality, the second modal data belongs to the original modality. By setting the pre-training task of locating local data that matches the second modal data from the first modal data, the multimodal submodel can establish a finer- grained local correspondence relationship between the multimodal data, thereby improving the performance of the target processing model on downstream tasks.

### BRIEF DESCRIPTION OF THE DRAWINGS

In conjunction with the accompanying drawings and with reference to the following detailed description, the above and other features, advantages and aspects of the various embodiments of the present disclosure will become more apparent. Throughout the drawings, like or similar reference numerals denote like or similar elements. It should be understood that the drawings are illustrative and that the originals and elements are not necessarily drawn to scale.

FIG. 1 illustrates an example flowchart of a processing method for multimodal data according to the embodiments of the present disclosure;

FIG. 2 illustrates an example flowchart a pre-training process of a multimodal submodel in a processing method for multimodal data according to the embodiments of the present disclosure;

FIG. 3 illustrates an example frame diagram for determining the target segment data in a pre-training process of a multimodal submodel in a processing method for multimodal data according to the embodiments of the present disclosure;

FIG. 4 illustrates an example frame diagram for constructing a first fusion feature from the first feature of the video segment data according to a processing method for multimodal data of the embodiments of the present disclosure;

FIG. 5 illustrates an example frame diagram for constructing a first fusion feature from the first feature of the text segment data according to a processing method for multimodal data of the embodiments of the present disclosure;

FIG. 6 illustrates an example schematic diagram of the structure of a processing apparatus for multimodal data provided by the embodiments of the present disclosure;

FIG. 7 illustrates an example schematic structural of an electronic device provided by the embodiments of the present disclosure.

### DETAILED DESCRIPTION

The following will describe embodiments of the present disclosure in more detail with reference to the accompanying drawings. Although certain embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are for illustrative purposes only and are not intended to limit the scope of protection of the present disclosure.

It should be understood that the various steps described in the implementations of the methods of the present disclosure may be executed in different orders and/or in parallel. In addition, the implementations of the methods may include additional steps and/or omit the steps shown. The scope of the present disclosure is not limited in this regard.

The term “including” and its variations used in this article are open-ended, i.e. “including but not limited to”. The term “based on” means “based at least in part on”. The term “one embodiment” refers to “at least one embodiment”; the term “another embodiment” refers to “at least one additional embodiment”; and the term “some embodiments” refers to “at least some embodiments”. Relevant definitions of other terms will be given in the following description.

It should be noted that the concepts of “first” and “second” mentioned in this disclosure are only used to distinguish different devices, modules, or units, and are not used to limit the order or interdependence of the functions performed by these devices, modules, or units.

It should be noted that the modifications of “one” and “multiple” mentioned in the present disclosure are illustrative and not restrictive. Those skilled in the art should understand that unless otherwise specified in the context, they should be understood as “one or more”.

It may be understood that the data involved in this technical solution (including but not limited to the data itself, data acquisition or use) should comply with the requirements of relevant laws and regulations and relevant provisions.

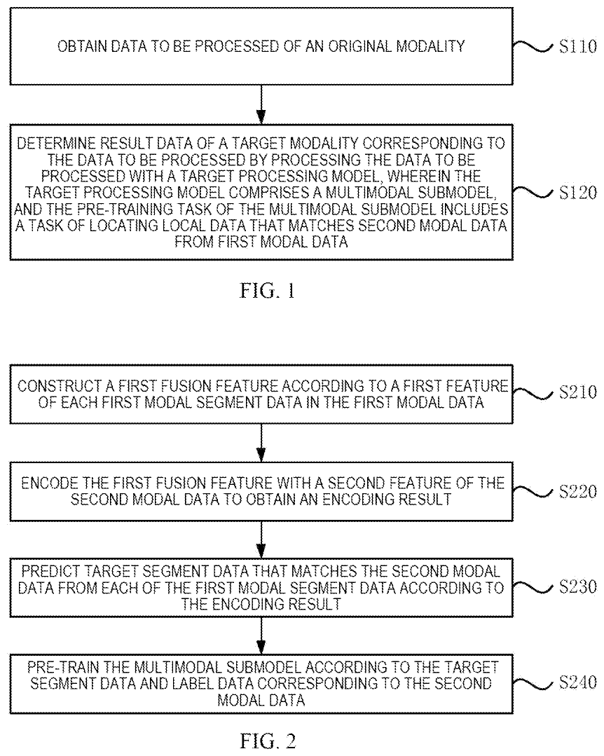

FIG. 1 is a schematic flowchart of a method for multimodal data processing provided by an embodiment of the present disclosure. The embodiment of the present disclosure is applicable to multimodal data processing, such as video text interlocalization, retrieval, generation, and multimodal video analysis. The method can be performed by an apparatus for multimodal data processing, which can be implemented in the form of software and/or hardware and which can be configured in an electronic device, such as a computer.

As shown in FIG. 1, the method for multimodal data processing provided in this embodiment may comprise:

S110: obtaining data to be processed of an original modality;

S120: determining result data of a target modality corresponding to the data to be processed by processing the data to be processed with a target processing model; wherein the target processing model includes a multimodal submodel, and a pre-training task of the multimodal submodel includes a task of locating local data that matches second modal data from first modal data.

In embodiments of the present disclosure, the original modality and the target modality generally refer to different modalities, and different modalities can be considered as different data types, e.g., including without limitation to, speech, text, images, videos and other modalities. With the trained target processing model, the input data to be processed of the original modality can be processed, and the result data of the target modality corresponding to the data to be processed can be determined.

In some optional implementations, the target processing model can be applied to at least one of the following tasks: a video-based text locating task, a text-based video temporal locating task, a video-based text retrieval task, a text-based video retrieval task, a video-based text generation task, a text-based video generation task, a video question answering task, and a video parsing task.

When the target processing model is applied to a video-based text locating task, the original modality may include video, and the target modality may include text; when the target processing model is applied to a text-based video temporal locating task, the original modality may include text, and the target modality may include video. In both cases, the determining the result data of the target modality corresponding to the data to be processed by processing the data to be processed with the target processing model may comprise: extracting a feature of the data to be processed and extracting a feature of data to be located of of the target modality with the target processing model; encoding the feature of the data to be processed and the feature of the data to be located to obtain an encoding result; and locating local data that matches the data to be processed from the data to be located based on the encoding result. The video-based text locating task may include, for example, a task of locating matched local text segments from long text based on an input video (abbreviated as text locating task); the text-based video temporal locating task may include, for example, a task of locating matched local video segments from a long video based on input text (abbreviated as an event locating task).

When the target processing model is applied to a video-based text retrieval task, the original modality may include video, and the target modality may include text; when the target processing model is applied to a text-based video retrieval task, the original modality may include text, and the target modality may include video. In both cases, the determining the result data of the target modality corresponding to the data to be processed by processing the data to be processed with the target processing model may comprise: extracting a feature of the data to be processed with the target processing model, and matching the extracted feature with features of each data of the target modality in a predetermined library to retrieve corresponding result data from the predetermined library. The video-based text retrieval task includes tasks such as determining a text description corresponding to a classification according to the video; the text-based video retrieval task includes tasks such as searching for relevant complete videos based on input keywords.

When the target processing model is applied to a video-based text generation task, the original modality may include video, and the target modality may include text; when the target processing model is applied to a text-based video generation task, the original modality may include text, and the target modality may include video. In both cases, the determining the result data of the target modality corresponding to the data to be processed by processing the data to be processed with the target processing model may comprise: extracting a feature of the data to be processed with the target processing model, and generating the result data of the corresponding target modality based on the extracted feature. The video-based text generation task includes tasks such as generating a text description corresponding to video content; the text-based video generation task includes tasks such as generating related videos based on input keywords.

When the target processing model is applied to a video question answering task, the original modality may include video, and the target modality may include text. At this time, the determining the result data of the target modality corresponding to the data to be processed by processing the data to be processed with the target processing model may comprise: extracting features of the video and question text with the target processing model, and generating answer text based on the features of the video and the question text. The video question answering task includes, for example, a video content comprehension task.

When the target processing model is applied to a video parsing task, the original modality may include video, and the target modality may include text. At this time, the determining the result data of the target modality corresponding to the data to be processed by processing the data to be processed with the target processing model may comprise: extracting features of the video with the target processing model; dividing the video into different video segments according to the features of the video, and generating text corresponding to the content of each video segment. The video parsing task includes, for example, a video content comprehension task.

In these optional implementation methods, the original modality can be one of video and text, and the target modality can be the other. Thereby, the processing of modal data between video and text can be realized, which helps to intelligently produce and analyze videos. In addition, the target processing model can also process other video and text tasks, as well as tasks between other multimodal data (such as mutual indexing and generation between audio and text), which are not exhausted here.

In the embodiments of the present disclosure, the target processing model may include a pre-trained multimodal submodel or a model structure for specific downstream tasks. The multimodal submodel may include, for example, a transformer model and other models with comprehension ability of different modal data. The pre-training task of the multimodal submodel may include a task of locating local data that matches the second modal data from the first modal data.

When the first modal data belongs to the original modal, the second modal data belongs to the target modal; when the first modal data belongs to the target modal, the second modal data belongs to the original modal. That is, the first modal data and the second modal data belong to different modalities, and the first modal data/second modal data belong to one of the original modal and the target modal. The task of locating local data that matches the second modal data from the first modal data can include but is not limited to the text locating task and event locating task described above.

By introducing the task of locating local data that matches the second modal data from the first modal data in the pre-training process of the multimodal submodel, the pre-trained multimodalm submodel can learn a finer-grained local correspondence between the multimodal data, thereby improving the performance of the target processing model to which the multimodal submodel belongs on downstream tasks (such as video text interlocating, retrieval, generation, and multimodal video analysis).

In addition, the pre-training task of the multimodal submodel can further include other tasks based on large-scale and broad multimodal data. The broad multimodal data can be considered as multimodal data that includes different domains and is not specific to downstream tasks. Through large-scale pre-training, the multimodal submodel can have high comprehension ability of multimodal data in different domains at the same time, extract common features between multimodal data in different domains, which is conducive to transferring the high comprehension ability of multimodal data to the target processing model to help the target processing model perform specific downstream tasks.

The technical solution of the embodiments of the present disclosure obtains the data to be processed of the original modality; and determines the result data of the target modality corresponding to the data to be processed by processing the data to be processed with the target processing model; wherein the target processing model includes a multimodal submodel, and the pre-training task of the multimodal submodel includes the task of locating local data that matches the second modal data from the first modal data; wherein when the first modal data belongs to the original modality, the second modal data belongs to the target modality; when the first modal data belongs to the target modality, the second modal data belongs to the original modality. By setting the pre-training task of locating local data that matches the second modal data from the first modal data, the multimodal submodel can establish a finer-grained local correspondence relationship between the multimodal data, thereby improving the performance of the target processing model on downstream tasks.

Various optional solutions in the method for multimodal data processing provided in this embodiment and the above embodiments of the present disclosure can be combined. The method for multimodal data processing provided in this embodiment describes in detail the pre-training process of the multimodal submodel. By fusing each first modal segment data into a longer first modal data and constructing a first fusion feature of the first modal data based on a first feature of each first modal segment data, a foundation can be laid for the pre-training task of locating local data from the data. Afterwards, the first fusion feature and the second feature of the given second modal data can be encoded, and target segment data in the first modal data that matches the second modal data can be predicted according to the encoding result for supervised training of the multimodal submodel, so that the pre-trained multimodal submodel can learn a finer-grained local correspondence between the multimodal data.

FIG. 2 is a schematic flowchart of the pre-training process of a multimodal submodel in a method for multimodal data processing provided by an embodiment of the present disclosure. As shown in FIG. 2, the pre-training process of the multimodal submodel in the method for multimodal data processing provided by this embodiment may comprise:

S210: constructing a first fusion feature based on a first feature of each first modal segment data in the first modal data.

In this embodiment, each first modal segment data has the same modality, and each first modal segment data may be joined into longer first modal data. Based on an existing feature extraction model, a first feature may be extracted from each first modal segment data. Thereafter, a first fusion feature corresponding to the first model data may be constructed based on each of the first features according to the concatenation order of the first modal data.

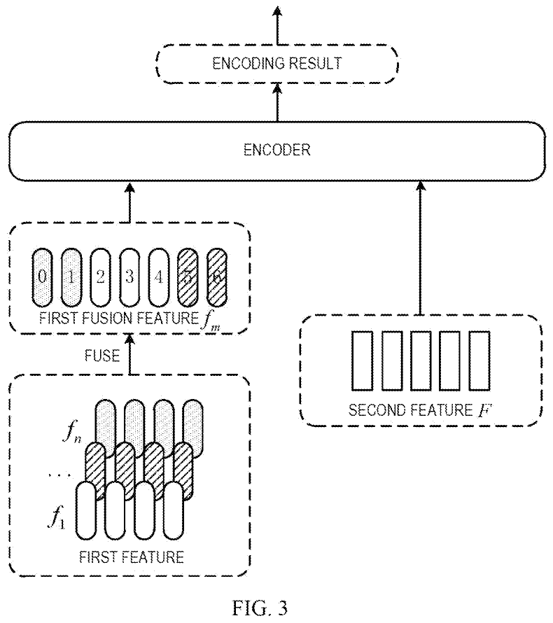

As an example, FIG. 3 is a schematic framework diagram for determining the target fragment data during the pre-training process of the multimodal submodel in the method for multimodal data processing provided by an embodiment of the present disclosure. As shown in FIG. 3, each of the first features may be denoted by f₁-fₙ, and each of the first features may be sequentially concatenated according to the concatenation order of the first modal data, and other processing (e.g., sampling processing, etc.) may be performed on each of the first features to obtain the first fusion feature.

S220: encoding the first fusion feature and a second feature of second modal data to obtain an encoding result.

When the first modal data belongs to the original modality, the second modal data belongs to the target modality; when the first modal data belongs to the target modality, the second modal data belongs to the original modality. The second feature can be extracted from the given second modal data based on the existing feature extraction model. The input first fusion feature and the second feature can be encoded based on the existing feature encoder to obtain the encoding result.

Referring to FIG. 3, the second feature can be represented as F, and the first fusion feature fₘ and the second feature F can be input into an encoder to obtain the encoding result through fine-grained interactive learning of multimodal data features. The encoder can be, for example, a Bidirectional Encoder Representation from Transformers (BERT) model based on Transformers.

S230: predicting target segment data that matches the second modal data from each of the first modal segment data according to the encoding result.

In this embodiment, the encoding result may be input to a decoder and other subsequent network layers, so that the subsequent network layer can predict the first feature matching the second feature from the first fusion feature according to the encoding result, and then can locate the corresponding first modal segment data from each of the first modal data according to the matched first feature, i.e., locate the target segment data matching the second modal data.

For example, referring again to FIG. 3, the first feature that matches the second feature F is f₁. Since the order of each of the first features in the first fusion feature corresponds to the order of the first modal segment data in the first modal data, the target segment data can be located from the first modal data according to the position information of the first feature f₁ in the first fusion feature fₘ, that is, the starting position 2 and the ending position 4 of the first feature at coordinates (2,4) in FIG. 3.

S240: pre-training the multimodal submodel according to the target segment data and label data corresponding to the second modal data.

The label data corresponding to the second modal data may be obtained in advance, and the label data may be first modal segment data really corresponding to the second modal data in the first modal data, or may be position information of the real corresponding first modal segment data in the first modal data.

When the label data is the real corresponding first modal segment data, a loss value can be determined based on an existing loss function and according to the target segment data and the real corresponding first modal segment data; when the label data is the real position information of the real corresponding first modal segment data in the first modal data, the loss value can be determined based on an existing loss function and according to the position information of the target segment data in the first modal data and the real position information. Afterwards, forward feedback can be performed based on the loss value to adjust parameters in the multimodal submodel, so that pre-training of the multimodal submodel can be completed.

The technical solution of the present disclosure describes the pre-training process of the multimodal submodel in detail. By fusing each of the first modal segment data into a longer first modal data and constructing a first fusion feature of the first modal data according to the first feature of each first modal segment data, a foundation can be laid for the pre-training task of locating local data from the data. Afterwards, the first fusion feature and the second feature of the given second modal data can be encoded, and the target segment data that matches the second modal data in the first modal data can be predicted according to the encoding result for supervised training of the multimodal submodel, so that the pre-trained multimodal submodel can learn a finer-grained local correspondence between the multimodal data.

In addition, the method for multimodal data processing provided by this embodiment and the method for multimodal data processing provided in the above embodiments belong to the same disclosure concept, technical details which are not described in detail in this embodiment may refer to the above embodiments, and the same technical features have the same beneficial effects in this present embodiment and the above embodiments.

Various optional solutions in the method for multimodal data processing provided in this embodiment and the above embodiments of the present disclosure can be combined. The method for multimodal data processing provided in this embodiment describes in detail the construction process of the first fusion feature of the long video. By constructing the first fusion feature of the long video, a foundation can be laid for the event locating task in pre-training, so that the pre-trained multimodal submodel learns the correspondence between complete text and fine-grained local video.

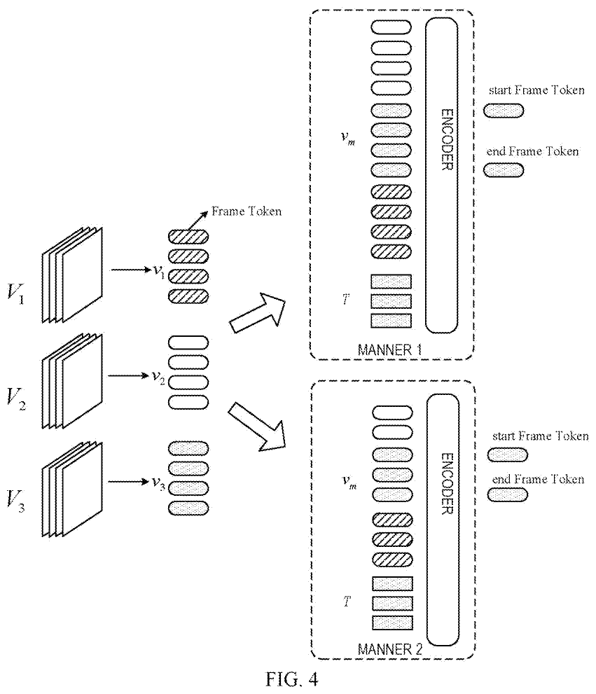

FIG. 4 is a schematic framework diagram for constructing a first fusion feature from a first feature of video segment data in a method for multimodal data processing provided by an embodiment of the present disclosure. As shown in FIG. 4, when each of the first modal segment data includes video segment data in the method for multimodal data processing provided by this embodiment, the first fusion feature is constructed based on at least one of the following methods:

Adjusting the order of each of the video segment data, and concatenating the first feature of each of the video segment data whose order has been adjusted; sampling each of the video segment data, and concatenating the first feature of each of the sampled video segment data.

In FIG. 4, the first modal data may include video segment data V₁-V₃, and the first features corresponding to V₁-V₃ are v₁-v₃; the first features v₁-v₃ can include each frame image token feature in the corresponding video segment data (represented by Frame Token in FIG. 4).

As an example, FIG. 4 shows two methods of constructing the first fusion feature, including:

Method 1: randomly adjusting the order of V₁-V₃ to the 3^{rd}, 1^{st}, and 2^{nd} (that is, the concatenation order of V₁-V₃ in the first modal data is the 3^{rd}, 1^{st}, and 2^{nd}); concatenating the corresponding first features v₁-v₃ according to the adjusted order to obtain the first fusion feature vₘ.

Method 2: sampling each of the first features v₁-v₃ according to the sampling way of V₁-V₃. For example, in FIG. 4, v₁ is sampled from four Frame Tokens into three Frame Tokens, v₂ is sampled from four Frame Tokens into two Frame Tokens, and v₃ is sampled from four Frame Tokens into three Frame Tokens; concatenating the sampled v₁-v₃, for example, according to the concatenation order of V₁-V₃ in the first modal data, to obtain the first fusion feature vₘ.

In addition to the two construction methods shown in FIG. 4, other methods can be used to construct the first fusion feature, such as: concatenating the sampled v₁-v₃ out of order (where the order of the sampled first feature v₃ corresponding to the label data cannot be disrupted) to obtain the first fusion feature vₘ. The concatenation order of the out-of-order concatenation needs to construct a correspondence relationship with the concatenation order of V₁-V₃ in the first modal data to facilitate the locating of the target segment data.

In some optional implementations, the label data corresponding to the second modal data may include: start and end frame position information of the video segment data corresponding to the second modal data in the first modal data.

For example, as shown in FIG. 4, the second modal data can be text data (such as a sentence), and the corresponding video segment data can be V₃. The label data corresponding to the second modal data can be the start and end frame position information of V₃ in the first modal data.

Accordingly, the features input into the encoder in FIG. 4 can include the first fusion feature vₘ and the second feature T of the second modal data; the start frame position information (start Frame Token) and end frame position information (end Frame Token) of the matched first feature in the first fusion feature vₘ can be predicted through the encoder. Furthermore, according to the start Frame Token and the end Frame Token, the start and end frame position information of the target segment data in the first modal data can be determined, and the multimodal submodel can be pre-trained based on the event locating task according to the predicted start and end frame position information and the start and end frame position information of V₃ in the first modal data.

In these optional implementations, the first fusion feature can be constructed based on the first feature by adjusting the order and/or sampling, thereby laying a foundation for the event locating task.

The technical solution of the embodiments of the present disclosure describes in detail the construction process of the first fusion feature of the long video. By constructing the first fusion feature of the long video, a foundation can be laid for the event locating task in pre-training, so that the pre-trained multimodal submodel can learn the correspondence between complete text and fine-grained local videos. Meanwhile, the modeling of video context temporal information can also be realized through the event locating task, which can improve the performance of the pre-trained model on more downstream tasks (such as video temporal positioning and other tasks).

Further, the method for multimodal data processing provided in this embodiment and the method for multimodal data processing provided in the above embodiments belong to the same disclosure concept, technical details which are not described in detail in this embodiment may refer to the above embodiments, and the same technical features have the same beneficial effects in the present embodiment and the above embodiments.

Various optional solutions in the method for multimodal data processing provided in this embodiment and the above embodiments of the present disclosure can be combined. The method for multimodal data processing provided in this embodiment describes in detail the construction process of the first fusion feature of long text. By constructing the first fusion feature of long text, a foundation can be laid for text locating tasks in pre-training, so that the pre-trained multimodal submodel learns the correspondence between complete video and fine-grained local text.

FIG. 5 is a schematic framework diagram for constructing a first fusion feature from a first feature of text segment data in a method for multimodal data processing provided in an embodiment of the present disclosure. As shown in FIG. 5, when each first modal fragment data includes text segment data in the method for multimodal data processing provided in this embodiment, the first fusion feature is constructed based on at least one of the following methods:

Adjusting the order of each text segment data, concatenating a first feature of each adjusted text segment data; extracting a segment token feature of each text segment data, and aggregating the various segment token features.

In FIG. 5, the first modal data may include text segment data T₁-T₃, and the corresponding first features of T₁-T₃ are t₁-t₃; the first features t₁-t₃ may include segment token features (represented by CLS Token in FIG. 5) and text features (represented by Text feature in FIG. 5) in the corresponding text segment data.

As an example, two methods of constructing the first fusion feature are shown in FIG. 5, including:

Method 1: adjusting the order of T₁-T₃ to the 3^{rd}, 1^{st}, and 2^{nd} respectively (that is, the concatenation order of T₁-T₃ in the first modal data is the 3^{rd}, 1^{st}, and 2^{nd}); according to the adjustment order, concatenating the corresponding first features t₁-t₃ to obtain the first fusion feature.

Method 2: extracting a segment token feature CLS Token from each of the first features v₁-v₃; aggregating each CLS Tokens, for example, concatenating according to v v the concatenation order of T₁-T₃ in the first modal data in FIG. 5 to obtain the first fusion feature tₘ.

In addition to the two construction methods shown in FIG. 5, other methods can be used to construct the first fusion feature, e.g., including: concatenating each CLS Token out of order to obtain the first fusion feature tₘ. The concatenation order of the out-of-order concatenation needs to construct a correspondence relationship with the concatenation order of T₁-T₃ in the first modal data to facilitate the locating of the target segment data.

In some optional implementations, the label data corresponding to the second modal data may include: start and end character position information or segment ordering information of the text segment data corresponding to the second modal data in the first modal data.

For example, referring to FIG. 5, the second modal data can be video segment data, and the corresponding text segment data can be T₁. The label data corresponding T to the second modal data can be start and end character position information or segment ordering information of T₁ in the first modal data.

Accordingly, the features input into the encoder in FIG. 5 can include the first fusion feature tₘ and the second feature V of the second modal data; through the V encoder, the start character position information (start CLS Token) and end character position information (end Text feature) of the matched first feature in the first fusion feature vₘ can be predicted, or the segment ordering information (matched CLS Token) v of the matched first feature in the first fusion feature can be predicted. Furthermore, according to the start CLS Token and the start CLS Token or the matched CLS Token, the start and end character position information or the segment ordering information of the target segment data in the first modal data can be determined, and the multimodal submodel can be pre-trained based on the text locating task according to the predicted start and end character position information and the start and end character position information of T₁ in the first modal data or according to the predicted segment ordering information and the segment ordering information of T₁ in the first modal data.T

In these optional implementations, the first fusion feature can be constructed based on each of the first features by adjusting the order and/or extracting the segment token features, thereby laying a foundation for the text locating task.

The technical solution of the embodiments of the present disclosure describes in detail the construction process of the first fusion feature of the long text. By constructing the first fusion feature of the long text, a foundation can be laid for the text locating task in pre-training, so that the pre-trained multimodal submodel can learn the correspondence between complete video and fine-grained local text. Further, the method for multimodal data processing provided in this embodiment and the method for multimodal data processing provided in the above embodiments belong to the same disclosure concept, technical details which are not described in detail in this embodiment may refer to the above embodiments, and the same technical features have the same beneficial effects in the present embodiment and the above embodiments.

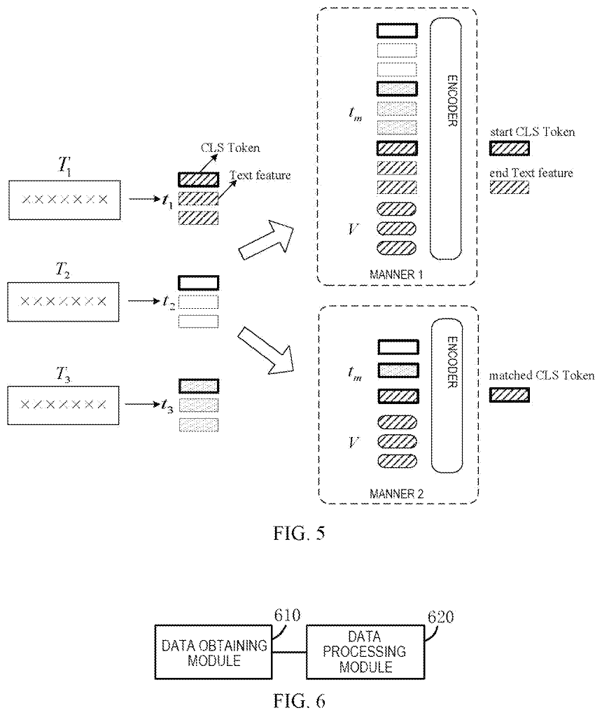

FIG. 6 is a schematic structural diagram of an apparatus for multimodal data processing provided by an embodiment of the present disclosure. The apparatus for multimodal data processing provided by this embodiment is applicable to multimodal data processing, such as video text inter-locating, retrieval, generation, and multimodal video analysis.

As illustrated in FIG. 6, a processing apparatus for multimodal data may include:
a data obtaining module 610, used for obtaining data to be processed of an original modality;
a data processing module 620, used for determining result data of a target modality corresponding to the data to be processed by processing the data to be processed with a target processing model;
wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

In some optional implementations, the processing apparatus for multimodal data may further include:
a modal pre-training module, may be used for training the multimodal submodel by the following steps:
constructing a first fusion feature according to a first feature of each first modal segment data in the first modal data;
encoding the first fusion feature with a second feature of the second modal data to obtain an encoding result;
predicting target segment data that matches the second modal data from each of the first modal segment data according to the encoding result;
pre-training the multimodal submodel according to the target segment data and label data corresponding to the second modal data.

In some optional implementations, the modal pre-training module may construct the first fusion feature by at least one of the following:
adjusting the order of each of the video segment data, and concatenating the first feature of each of the video segment data whose order has been adjusted;
sampling each of the video segment data, and concatenating the first feature of each of the sampled video segment data.

In some optional implementations, the label data corresponding to the second modal data may comprise: start and end frame position information of video segment data corresponding to the second modal data in the first modal data.

In some optional implementations, when each of the first modal segment data comprises text segment data, the first fusion feature may be constructed based on at least one of:
adjusting the order of each of the text segment data, and concatenating the first feature of each of the text segment data;
extracting a fragment token feature of each of the text segment data and aggregating each of the segment token features.

In some optional implementations, the label data corresponding to the second modal data may comprise: start and end character position information or segment ordering information of text segment data corresponding to the second modal data in the first modal data.

In some optional implementations, the target processing model may be applied to at least one of:
a video-based text locating task, a text-based video temporal locating task, a video-based text retrieval task, a text-based video retrieval task, a video-based text generation task, a text-based video generation task, a video question-answer task, and a video parsing task.

Embodiments of a processing apparatus for multimodal data provided by the embodiments of the present disclosure, may perform processing methods for multimodal data provided by the embodiments of the present disclosure, and the processing apparatus for multimodal data may have corresponding functional modules for performing the method and may achieve beneficial effects.

It is should be noted that the various units and modules included in the above- mentioned device are only divided according to functional logic, but are not limited to the above-mentioned division, as long as the corresponding functions may be realized; in addition, the specific names of each functional unit are only for ease of distinction from each other, it is not used to limit the scope of protection of the present disclosure.

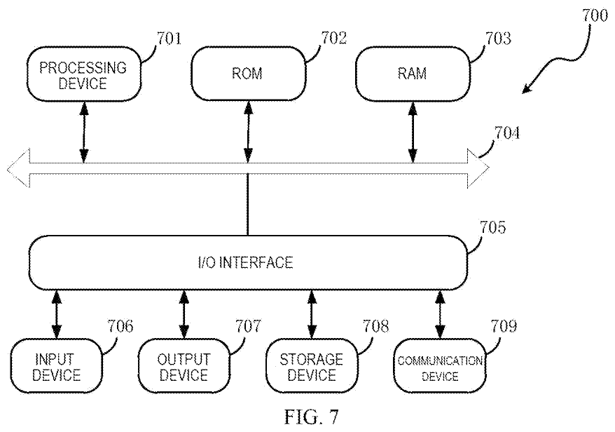

Referring now to FIG. 7, which shows a schematic structural diagram of an electronic device suitable for implementing embodiments of the present disclosure (e.g., a terminal device or server in FIG. 7) 700. The terminal devices in the present disclosure may include but are not limited to mobile phones, laptops, digital broadcast receivers, PDAs (personal digital assistants), PADs (tablets), PMPs (portable multimedia players), vehicle devices (such as vehicle navigation devices), and fixed terminal devices such as digital TVs, desktop computers, etc. The electronic device shown in FIG. 7 is only an example and should not limit the functionality and scope of use of the present disclosure embodiment.

As shown in FIG. 7, the electronic device 700 may include a processing device (such as a central processor, graphics processing unit, etc.) 701, which may perform various appropriate actions and processes based on programs stored in a read-only memory (ROM) 702 or loaded from a storage device 708 into a random access memory (RAM) 703. In RAM 703, various programs and data required for the operation of the electronic device 700 are also stored. The processing device 701, ROM 702, and RAM 703 are connected to each other through a bus 704. The input/output (I/O) interface 705 is also connected to the bus 704.

Generally, the following devices can be connected to the I/O interface 705: input devices 707, including touch screens, touchpads, keyboards, mice, cameras, microphones, accelerometers, gyroscopes, etc.; output devices 707, including liquid crystal displays (LCDs), speakers, vibrators, etc.; storage devices 708, including magnetic tapes, hard disks, etc.; and communication devices 709. Communication devices 709 can allow electronic devices 700 to communicate wirelessly or wirelessly with other devices to exchange data. Although FIG. 4 shows an electronic device 700 with various devices, it should be understood that it is not required to implement or have all of the devices shown. More or fewer devices may be implemented or provided alternatively.

In particular, according to embodiments of the present disclosure, the process described above with reference to the flowchart may be implemented as a computer software program. For example, embodiments of the present disclosure include a computer program product comprising a computer program carried on a non-transitory computer-readable medium, the computer program comprising program code for performing the method shown in the flowchart. In such embodiments, the computer program may be downloaded and installed from the network through the communication device 709, or is installed from the storage device 708, or is installed from the ROM 702. When the computer program is executed by the processing device 701, the above-described functions defined in the method of the present disclosure are performed.

It should be noted that the computer-readable medium described above in this disclosure can be a computer-readable signal medium or a computer-readable storage medium or any combination thereof. The computer-readable storage medium can be, for example, but not limited to, an electrical, magnetic, optical, electromagnetic, infrared, or semiconductor system, device, or any combination thereof. More specific examples of computer-readable storage media may include but are not limited to: an electrical connection with one or more wires, a portable computer disk, a hard disk, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In this disclosure, a computer-readable storage medium may be any tangible medium containing or storing a program that may be used by or in conjunction with an instruction execution system, apparatus, or device. In this disclosure, a computer-readable signal medium may include a data signal propagated in a baseband or as part of a carrier wave, which carries computer-readable program code. Such propagated data signals may take many forms, including but not limited to electromagnetic signals, optical signals, or any suitable combination thereof. Computer-readable signal media may also be any computer-readable medium other than computer-readable storage media, which may send, propagate, or transmit programs for use by or in conjunction with instruction execution systems, apparatuses, or devices. The program code contained on the computer-readable medium can be transmitted using any suitable medium, including but not limited to: wires, optical cables, RF (radio frequency), etc., or any suitable combination thereof.

In some embodiments, the client and server may communicate by using any currently known or future developed network protocol such as HTTP (HyperText Transfer Protocol), and may be interconnected with any form or medium of digital data communication (e.g., a communication network). Examples of communication networks include local area network (“LAN”), wide area network (“WAN”), the Internet (e.g., the Internet), and end-to-end networks (e.g., ad hoc end-to-end networks), as well as any currently known or future developed networks.

The computer-readable medium may be included in the electronic device, or it may exist alone and not assembled into the electronic device.

The above-mentioned computer-readable medium carries one or more programs, and when the above-mentioned one or more programs are executed by the electronic device, the electronic device is caused to:
obtain data to be processed of an original modality; determine result data of a target modality corresponding to the data to be processed by processing the data to be processed with a target processing model; wherein the target processing model comprises a multimodal submodel, and the pre-training task of the multimodal submodel includes a task of locating local data that matches second modal data from first modal data; wherein when the first modal data belongs to the original modality, the second modal data belongs to the target modality;

when the first modal data belongs to the target modality, the second modal data belongs to the original modality.

Computer program code for performing the operations of the present disclosure may be drafted in one or more programming languages, or combinations thereof, including but not limited to object-oriented programming languages, such as, Java, Smalltalk, C++, and also including conventional procedural programming languages such as “C” language or similar programming languages. The program code may be executed entirely on the computer of the user, partially on the computer of the user, as a standalone software package, partially on the user's computer, or entirely on the remote computer or server. In the case of a remote computer, the remote computer may be connected to the user's computer through any type of network, including a local area network (LAN) or a wide area network (WAN), or may be connected to an external computer (e.g., using an Internet service provider to connect via the Internet).

The flowcharts and block diagrams in the accompanying drawings illustrate the architecture, functions, and operations of systems, methods, and computer program products that may be implemented in accordance with various embodiments of the present disclosure. in this regard, each block in the flowchart or block diagram may represent a module, program segment, or portion of code that contains one or more executable instructions for implementing a specified logical function. It should also be noted that in some alternative implementations, the functions marked in the blocks may also occur in a different order than those marked in the figures. For example, two blocks represented in succession may actually be executed substantially in parallel, and they may sometimes be executed in the opposite order, depending on the function involved. It should also be noted that each block in the block diagram and/or flowchart, and combinations of blocks in the block diagram and/or flowchart, may be implemented using a dedicated hardware-based system that performs the specified function or operation, or may be implemented using a combination of dedicated hardware and computer instructions.

The modules described in the disclosed embodiments can be implemented by software or hardware. The name of the module does not limit the module itself in some cases. For example, the allocation module can also be described as “when creating a virtual machine in TCE-metal, assign the corresponding bare metal device module to the virtual machine.”

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), system-on-chip (SOCs), complex programmable logic devices (CPLDs), and the likes.

In the context of this disclosure, machine-readable media can be tangible media that can contain or store programs for use by or in conjunction with instruction execution systems, devices, or devices. Machine-readable media can be machine-readable signal media or machine-readable storage media. Machine-readable media may include, but may be not limited to, electronic, magnetic, optical, electromagnetic, infrared, or semiconductor systems, apparatuses, or devices, or any suitable combination thereof. More specific examples of machine-readable storage media may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, [example 1] provides a processing method for multimodal data, the method includes:
obtaining data to be processed of an original modality;
determining result data of a target modality corresponding to the data to be processed by processing the data to be processed with a target processing model;
wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

According to one or more embodiments of the present disclosure, [example 2] provides a processing method for multimodal data, further including:
in some optional implementations, the pre-training process of the multimodal submodel includes:
constructing a first fusion feature according to a first feature of each first modal segment data in the first modal data;
encoding the first fusion feature with a second feature of the second modal data to obtain an encoding result;

predicting target segment data that matches the second modal data from each of the first modal segment data according to the encoding result;
pre-training the multimodal submodel according to the target segment data and label data corresponding to the second modal data.

According to one or more embodiments of the present disclosure, [example 3] provides a processing method for multimodal data, further including:

in some optional implementations, when each of the first modal segment data comprises video segment data, the first fusion feature is constructed based on at least one of:

adjusting the order of each of the video segment data, and concatenating the first feature of each of the video segment data whose order has been adjusted;

sampling each of the video segment data, and concatenating the first feature of each of the sampled video segment data.

According to one or more embodiments of the present disclosure, [example 4] provides a processing method for multimodal data, further including:
in some optional implementations, the label data corresponding to the second modal data comprises: start and end frame position information of video segment data corresponding to the second modal data in the first modal data.

According to one or more embodiments of the present disclosure, [example 5] provides a processing method for multimodal data, further including:
in some optional implementations, when each of the first modal segment data comprises text segment data, the first fusion feature is constructed based on at least one of:
adjusting the order of each of the text segment data, and concatenating the first feature of each of the text segment data;
extracting a fragment token feature of each of the text segment data and aggregating each of the segment token features.

According to one or more embodiments of the present disclosure, [example 6] provides a processing method for multimodal data, further including:
in some optional implementations, the label data corresponding to the second modal data comprises: start and end character position information or segment ordering information of text segment data corresponding to the second modal data in the first modal data.

According to one or more embodiments of the present disclosure, [example 7] provides a processing method for multimodal data, further including:
in some optional implementations, the target processing model is applied to at least one of:
a video-based text locating task, a text-based video temporal locating task, a video-based text retrieval task, a text-based video retrieval task, a video-based text generation task, a text-based video generation task, a video question-answer task, and a video parsing task.

According to one or more embodiments of the present disclosure, [example 8] provides a processing method for multimodal data, including:
a data obtaining module, used for obtaining data to be processed of an original modality;
a data processing module, used for determining result data of a target modality corresponding to the data to be processed by processing the data to be processed with a target processing model;
wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

The above description is only the preferred embodiment of the present disclosure and an explanation of the technical principles used. Those skilled in the art should understand that the scope of the disclosure involved in the present disclosure is not limited to the specific combination of the above technical features, but should also cover other technical solutions formed by any combination of the above technical features or their equivalent features without departing from the above disclosure concept. For example, the technical solution formed by replacing the above features with (but not limited to) technical features with similar functions disclosed in the present disclosure.

In addition, although the operations are depicted in a specific order, this should not be understood as requiring these operations to be performed in the specific order shown or in sequential order. Under certain circumstances, multitasking and parallel processing may be advantageous. Similarly, although several specific implementation details are included in the above discussion, these should not be construed as limiting the scope of the present disclosure. Certain features described in the context of individual embodiments may also be implemented in combination in a single embodiment. Conversely, various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the particular features or acts described above. Rather, the particular features and acts described above are merely exemplary forms of implementation of the claims.

What is claimed is:

1. A processing method for multimodal data, comprising:
obtaining data to be processed of an original modality; and
determining result data of a target modality corresponding to the data to be processed by processing the data to be processed with a target processing model;
wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

2. The method of claim 1, wherein the pre-training process of the multimodal submodel comprises:
constructing a first fusion feature according to a first feature of each first modal segment data in the first modal data;
encoding the first fusion feature with a second feature of the second modal data to obtain an encoding result;
predicting target segment data that matches the second modal data from each of the first modal segment data according to the encoding result; and
pre-training the multimodal submodel according to the target segment data and label data corresponding to the second modal data.

3. The method of claim 2, wherein when each of the first modal segment data comprises video segment data, the first fusion feature is constructed based on at least one of:
adjusting the order of each of the video segment data, and concatenating the first feature of each of the video segment data whose order has been adjusted; or
sampling each of the video segment data, and concatenating the first feature of each of the sampled video segment data.

4. The method of claim 3, wherein the label data corresponding to the second modal data comprises: start and end frame position information of video segment data corresponding to the second modal data in the first modal data.

5. The method of claim 2, wherein when each of the first modal segment data comprises text segment data, the first fusion feature is constructed based on at least one of:
adjusting the order of each of the text segment data, and concatenating the first feature of each of the text segment data; or
extracting a fragment token feature of each of the text segment data and aggregating each of the segment token features.

6. The method of claim 5, wherein the label data corresponding to the second modal data comprises: start and end character position information or segment ordering information of text segment data corresponding to the second modal data in the first modal data.

7. The method of claim 1, wherein the target processing model is applied to at least one of:
a video-based text locating task, a text-based video temporal locating task, a video-based text retrieval task, a text-based video retrieval task, a video-based text generation task, a text-based video generation task, a video question-answer task, or a video parsing task.

8. An electronic device comprising:
a processor;
a memory for storing a computer program;
wherein the computer program, when executed by the processor, causes the electronic device to perform operations comprising:
obtaining data to be processed of an original modality; and
determining result data of a target modality corresponding to the data to be processed by processing the data to be processed with a target processing model;
wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

9. The electronic device according to claim 8, wherein the pre-training process of the multimodal submodel comprises:
constructing a first fusion feature according to a first feature of each first modal segment data in the first modal data;
encoding the first fusion feature with a second feature of the second modal data to obtain an encoding result;
predicting target segment data that matches the second modal data from each of the first modal segment data according to the encoding result; and
pre-training the multimodal submodel according to the target segment data and label data corresponding to the second modal data.

10. The electronic device according to claim 9, wherein when each of the first modal segment data comprises video segment data, the first fusion feature is constructed based on at least one of:
adjusting the order of each of the video segment data, and concatenating the first feature of each of the video segment data whose order has been adjusted; or
sampling each of the video segment data, and concatenating the first feature of each of the sampled video segment data.

11. The electronic device according to claim 10, wherein the label data corresponding to the second modal data comprises: start and end frame position information of video segment data corresponding to the second modal data in the first modal data.

12. The electronic device according to claim 9, wherein when each of the first modal segment data comprises text segment data, the first fusion feature is constructed based on at least one of:
adjusting the order of each of the text segment data, and concatenating the first feature of each of the text segment data; or
extracting a fragment token feature of each of the text segment data and aggregating each of the segment token features.

13. The electronic device according to claim 12, wherein the label data corresponding to the second modal data comprises: start and end character position information or segment ordering information of text segment data corresponding to the second modal data in the first modal data.

14. The electronic device according to claim 8, wherein the target processing model is applied to at least one of:
a video-based text locating task, a text-based video temporal locating task, a video-based text retrieval task, a text-based video retrieval task, a video-based text generation task, a text-based video generation task, a video question-answer task, or a video parsing task.

15. A non-transitory computer-readable storage medium, wherein the computer readable-storage medium stores instructions which, when executed on an electronic device, cause the electronic device to perform operations comprising:
obtaining data to be processed of an original modality; and
determining result data of a target modality corresponding to the data to be processed by processing the data to be processed with a target processing model;
wherein the target processing model comprises a multimodal submodel, and the pre-training task of the multimodal submodel includes a task of locating local data that matches second modal data from first modal data; wherein when the first modal data belongs to the original modality, the second modal data belongs to the target modality; when the first modal data belongs to the target modality, the second modal data belongs to the original modality.

16. The non-transitory computer-readable storage medium according to claim 15, wherein the pre-training process of the multimodal submodel comprises:
constructing a first fusion feature according to a first feature of each first modal segment data in the first modal data;
encoding the first fusion feature with a second feature of the second modal data to obtain an encoding result;
predicting target segment data that matches the second modal data from each of the first modal segment data according to the encoding result; and
pre-training the multimodal submodel according to the target segment data and label data corresponding to the second modal data.

17. The non-transitory computer-readable storage medium according to claim 16, wherein when each of the first modal segment data comprises video segment data, the first fusion feature is constructed based on at least one of:
adjusting the order of each of the video segment data, and concatenating the first feature of each of the video segment data whose order has been adjusted; or
sampling each of the video segment data, and concatenating the first feature of each of the sampled video segment data.

18. The non-transitory computer-readable storage medium according to claim 17, wherein the label data corresponding to the second modal data comprises: start and end frame position information of video segment data corresponding to the second modal data in the first modal data.

19. The non-transitory computer-readable storage medium according to claim 16, wherein when each of the first modal segment data comprises text segment data, the first fusion feature is constructed based on at least one of:
adjusting the order of each of the text segment data, and concatenating the first feature of each of the text segment data; or
extracting a fragment token feature of each of the text segment data and aggregating each of the segment token features.

20. The non-transitory computer-readable storage medium according to claim 19, wherein the label data corresponding to the second modal data comprises: start and end character position information or segment ordering information of text segment data corresponding to the second modal data in the first modal data.
